(19) United States
(12) Patent Application Publication
(10) Pub. No.: US 2002/0072328 A1
(43) Pub. Date: Jun. 13, 2002

(54) Method of managing a mobile radio network, and a mobile radio network infrastructure

(75) Inventors: Alain Guirauton, Argenteuil (FR); Francis Pinault, Bois-Colombes (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 09/994,642

(22) Filed: Nov. 28, 2001

(30) Foreign Application Priority Data
Dec. 7, 2000 (FR) 00 15 886

(51) Int. Cl. H04H 1/00

(52) U.S. Cl. 455/3.05; 455/422; 455/426

(57) ABSTRACT

A method of managing a mobile radio network is disclosed which is intended for use in a mobile radio network provided with a mobile infrastructure, for example because it is located on a ship. A ship may be located either in an area that is not served by any public mobile radio network or in an area that is served by a public mobile radio network. A first objective of the method disclosed is to enable the ship to communicate with a public telephone network at the lowest cost in all cases. A second objective is to avoid interference if a fixed infrastructure mobile radio network is using resources that are also being used by the network on board the ship. The mobile infrastructure network detects transmissions from other mobile radio networks in order to switch from a satellite link used only when the ship is outside areas served by public mobile radio networks to a link to a fixed infrastructure mobile radio network to which it can be connected, and then, in conjunction with the fixed infrastructure mobile radio network, to initiate a procedure for determining and sharing transmit frequencies.

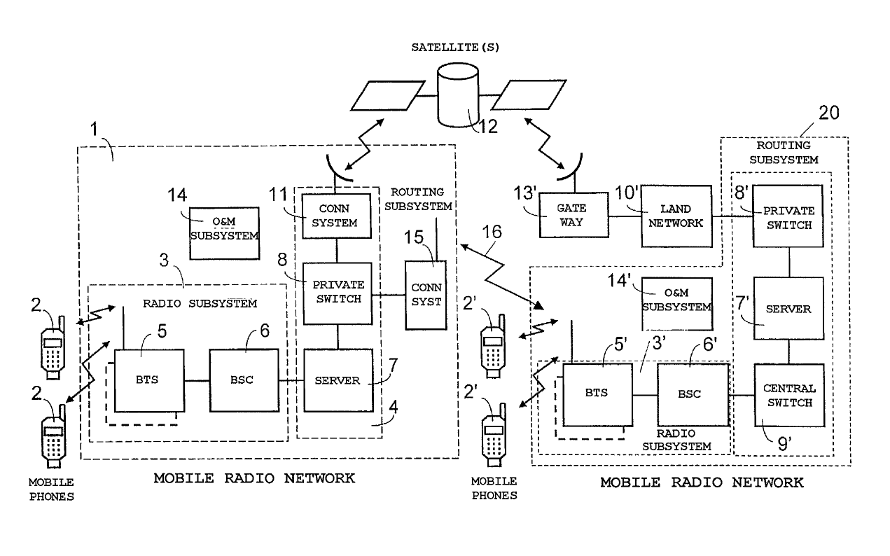

### CROSS-REFERENCE TO RELATED APPLICATIONS

This application is based on French Patent Application No. 00 15 886 filed Dec. 7, 2000, the disclosure of which is hereby incorporated by reference thereto in its entirety, and the priority of which is hereby claimed under 35 U.S.C. §119.

### BACKGROUND OF THE INVENTION

1. Field of the invention

The invention relates to a method of managing a radio mobile network that has a mobile infrastructure, for example because it is installed on a ship.

2. Description of the prior art

A mobile radio network on board a ship enables passengers to make telephone calls using their ordinary mobile telephones, for example GSM phones. However, for passengers to be able to communicate with the rest of the world, the mobile infrastructure network must be connected to a public telecommunication network at all times. Also, the mobile radio network must be prevented from interfering with fixed infrastructure mobile radio networks.

Land mobile radio networks share a set of predetermined resources (radio channels or time slots, depending on the type of network). Each land mobile radio network therefore has access to a particular group of resources intended to be used in a particular continental area for calls involving mobile telephones. Resources are divided between land networks so that networks of different operators use different resources in geographical areas in which they coexist; the resources are allocated to them in a fixed manner. The same resources can be allocated to different mobile radio networks in different continental areas.

There is no provision for dynamic allocation of resources. Nevertheless, there are situations in which it is desirable to be able to accommodate temporarily another mobile radio network having a mobile infrastructure, within a geographical area covered by one or more land networks having a fixed infrastructure. The other network uses resources that may be identical to resources employed by the fixed infrastructure networks in the area concerned.

Mobile infrastructures of this kind are installed in large passenger vehicles, for example ships or aircraft. They can also be transported from one temporary site to another, to meet localized and temporary requirements, for example in connection with a commercial and/or sporting event or to support aid or rescue services.

It is also possible for a plurality of mobile infrastructure networks with access to identical resources to be neighbors temporarily, for example a plurality of ships in the same port or in the same area in which ship movements are regulated.

U.S. Pat. No. 5,867,785 describes a mobile infrastructure network installed on a train. The train moves in an area entirely covered by a fixed infrastructure mobile radio network. The mobile infrastructure includes a controller that scans the control channels transmitted by base stations of the fixed infrastructure network. The mobile infrastructure controller determines the quality of each signal received to determine the nearest base station. It registers with the fixed infrastructure network controller via that base station. The controller allocates it a set of resources (radio channels or time slots, depending on the type of network) which is a subset of the set of resources allocated to the base station with which it has registered. Thus the mobile infrastructure network becomes an extension of the fixed infrastructure network.

In a different embodiment, the mobile infrastructure network controller scans the control channels transmitted by the base stations of the fixed infrastructure network. It determines the quality of each signal received to determine the fixed base stations that are sufficiently close to cause interference with the mobile infrastructure network. It prohibits itself from allocating resources used by the fixed base stations from which it receives with a level of quality higher than a fixed threshold, and deduces therefrom a set of resources that it can use, choosing resources used by a base station from which it does not receive with a quality level higher than a fixed threshold. The mobile infrastructure network therefore operates autonomously with respect to the fixed infrastructure network, without interfering with it.

This kind of system cannot be transposed directly to a ship because a ship can go anywhere, unpredictably. A ship can be either in an area that is not serviced by any fixed infrastructure mobile radio network or in an area that is serviced by a fixed infrastructure mobile radio network. A first object of the invention is for the network to be able communicate with a public telephone network at the lowest cost in all cases. A second object is to avoid interference with one or more fixed infrastructure mobile radio networks that can use the same radio resources as the mobile infrastructure network.

### SUMMARY OF THE INVENTION

The invention consists in a method of managing a mobile infrastructure mobile radio network, including:

setting up a connection between the mobile infrastructure mobile radio network and a fixed telephone network via a satellite when the mobile infrastructure mobile radio network is far away from any fixed infrastructure mobile radio network with which it could set up a radio link, and

setting up a radio link between the mobile infrastructure mobile radio network and a fixed infrastructure mobile radio network when the mobile infrastructure mobile radio network is near the fixed infrastructure mobile radio network and they can set up a radio link between them.

The invention also relates to a mobile radio network mobile infrastructure for implementing the above management method.

The invention, its features and its advantages are explained in the following description, which is given with reference to the single FIGURE of the accompanying drawing.

### BRIEF DESCRIPTION OF THE DRAWING

The single FIGURE is a block diagram of a fixed infrastructure mobile radio network and a mobile infrastructure mobile radio network situated on board a ship, for example.

### DETAILED DESCRIPTION OF THE PREFERRED EMBODIMENT

The mobile infrastructure mobile radio network 1 has connecting means 11 enabling it to route calls to a public land telecommunication network 10′ via a satellite 12 or a constellation of satellites when it is at sea or in any other area with no usable telecommunication means. However, it also has connecting means 15 enabling it to set up a radio link 16 with a fixed infrastructure mobile radio network 20, to route calls to a public land telecommunication network 10′ when the ship is near the coast or in port. The network 1 can further include connecting means (not shown) for using cable links or radio links when the ship is stationary in a port. The public land telecommunication network 10′ is connected to a station 13′ constituting a gateway for setting up a radio link with the satellite 12 or a constellation of satellites.

The networks 1 and 20 are GSM (Global System for Mobile communications) or UMTS (Universal Mobile Telecommunication System) mobile radio networks, for example. The network 1 services mobile terminals 2 on board the ship. It has a conventional infrastructure divided into three main subsystems:

a radio subsystem 3 which handles transmission to and from the mobile terminals 2 and manages the radio resources that enable such transmission;

a routing subsystem 4 which provides all of the functions necessary for outgoing or incoming call set-up in relation to the mobile terminals 2; and

an operation and maintenance subsystem 14.

The fixed infrastructure mobile radio network 20 also has a radio subsystem 3′ servicing mobile terminals 2′ and a routing subsystem 4′. The radio subsystems of the mobile infrastructure network 1 and the fixed infrastructure network 20 are similar. For example, they include respective base transceiver stations 5, 5′ and each includes a respective base station controller 6, 6′.

The routing subsystems of the two networks 1 and 20 are structured slightly differently because of their respective specific features. The routing subnetwork 4 of the mobile infrastructure network 1 is a priori smaller than that of the fixed infrastructure network 20. It essentially includes a server 1 dedicated to the operator managing the network 1. In this example, the server 7 is a conventional GSM network operator server. The server 7 is installed between the network controller 6 and a private multiservice telephone switch 8 dedicated to the network 1. The switch 8 is connected:

to the connecting means 11, consisting of an access unit for setting up a radio link to the satellite 12, and

the connecting means 15, consisting of a radio transceiver for setting up a radio link 16 capable of transporting a plurality of simultaneous telephone calls to a base station of another mobile radio network, in particular a GSM network such as the network 20.

In the fixed infrastructure mobile radio network 20, the routing subnetwork 4′ includes an operator server 7′ corresponding functionally to the server 7, for example. The server 7′ is connected to a dedicated central mobile services switch 9′ to which the controller 6′ is connected. In the example shown, the server 7′ is connected to the public land telecommunication network 10′ via a private switch 8′ .

For the network 1 to be able to communicate with the network 20, the networks must include connecting means whose bit rate is sufficient for setting up a plurality of simultaneous calls and transmitting diverse information signals and signaling. It is then possible for the operation and maintenance subsystems 14 and 14′ to communicate with each other, under known conditions, for example by means of conventional signaling protocols, such as the SS7 protocol.

As is known in the art, an operator of a GSM land mobile radio network covering a particular continental area has access to a band of frequencies that is allocated to the operator to enable it to service mobile terminals that are in that area and registered with the network. Other frequency bands are allocated to the operators who also have access to fixed infrastructure GSM mobile radio networks that cover the particular area referred to above at least partly. These bands are chosen to be different to prevent the risks of interference associated with the use of the same frequency by transmitters used in different mobile radio networks.

On the other hand, an operator of a mobile infrastructure GSM network, for example a network whose infrastructure is on board an oceangoing ship, may not be included in the frequency plan in accordance with which bands are allocated to the various operators for a given continental area. The mobile infrastructure GSM network is therefore liable to use frequencies allocated to others if it is temporarily located in their area.

The radio transceiver 15 is adapted to detect transmission in a mobile radio network other than the network 1. For example, before calls set up with mobile terminals via one or the other of the networks can be disturbed, the equipment scans the various frequencies that can be used for mobile radio calls to detect the presence of another mobile radio network in the vicinity, for example by searching for beacon channels that characterize the various base stations of the mobile radio networks and contain information identifying the network of which they are part and its access characteristics. As is known in the art in the context of the GSM network, the beacon channel of a base station consists of a modulated signal, referred to as the beacon frequency, transmitted by the station to the mobile terminals continuously and at constant power, and by a set of broadcast channels on the beacon frequency, one of which channels, called the broadcast control channel (BCCH), includes the identification information referred to above.

The detection operations carried out by the transceiver 15 are controlled by a program for determining the mobile radio environment in which the network 1 is situated and installed in a dedicated module of the operating subsystem 14 of the network.

The detection and sharing operations are as follows:

In a first step, the operating subsystem 14 of the network 1 prohibits the use of frequencies that can be used for communicating with mobile terminals and which have already been allocated to a base station that is external to the network 1 and whose BCCH has been detected. The network detected is the network 20, for example.

In a second step, the operating subsystem 14 of the network 1 starts a dialog between the network 1 and the detected network 20. A connection is set up at this time between the operating subsystems 14 and 14′ of the two networks 1 and 20, via the access unit 11, the satellite 12, the station 13′ and the public land network 10′.

In a third step, if the two networks 1 and 20 have been able to dialog and agree to set up a connection via the transceiver 15, the operating subsystem 14 of the network 1 commands the switch 8 to route telephone calls via the transceiver 15 instead of via the access means 111 to the satellite 12.

As is known in the art, each operating subsystem 14, 14′ is connected to the other subsystems of the mobile radio network of which it is part in an appropriate manner that is not described further here in that it is not directly relevant to the subject matter of the present invention.

Of course, a connection can also be set up between two mobile infrastructure networks (two ships) within radio range of each other in the same geographical area, in the context of a dialog procedure as referred to above. It can also be envisaged that the same network 1 has to set up a plurality of dialogs, or a conference procedure having the same function, if it is simultaneously in a geographical area that is covered by a plurality of other mobile radio networks.

The dialog with another network initiated by a network 1 is intended to determine which frequencies it will be able to use when it is in the same geographical area as the detected network. To this end, it is necessary for the respective operating systems 14 and 14′ of the networks 1 and/or 20 concerned to be equipped with resource sharing means that inform each of the two networks 1 and 20 of the frequencies that it can use.

The sharing means are software means whose implementation will be evident to the person skilled in the art, and can be organized in different ways, depending on whether the mobile radio networks concerned are considered on a basis of equality or in accordance with a master-slave type relationship. In the former case, the two networks 1 and 20 are provided with functionally identical or mutually compatible sharing means.

They are programmed to agree on which frequencies will be used by one and prohibited to the other. In the latter case, if the network 1 is considered as the slave network, the sharing means provided in the operating system 14 of the network 1 can be limited to means for registering frequencies for which it is authorized when it is in an area in which there is another mobile radio network, for example the network 20, intended to operate as a master network, and consequently to decide on frequency allocation in accordance with a predetermined program and as a function of the current situation.

It is standard practice to use the same frequencies again for calls in different cells of the same mobile radio network that cover a particular continental geographical area if the cells are sufficiently far apart to enable this, which is generally the case.

In the case of a fixed infrastructure mobile radio network in an area bordered by a coastline, base stations are not normally provided beyond the coastline. It is therefore possible to allocate another mobile radio network, and in particular a network on a ship, frequencies that are used by base stations specific to cells at a distance from the coast.

In one embodiment, the mobile radio network cells that define the base stations 5 of the mobile infrastructure network 1 are taken into account as new cells of the fixed infrastructure of a mobile radio network situated in the geographical coverage area in which the network 1 is temporarily located. That assimilation is effected by means of a process involving cooperation between the operating subsystems 14 and 14′of the two networks 1 and 20 concerned. It is then possible for the mobile terminals initially serviced by one of the two networks to move into the geographical area covered by one and/or the other of them without interrupting calls that have been set up, by exploiting roaming procedures provided for this purpose in both networks.

Using such dispositions is also envisaged in the case of two mobile infrastructure networks, for example two ships near each other, so that their respective coverage areas overlap.

The scope of the invention is not limited to GSM and UMTS networks. How to adapt the method and the mobile infrastructure to other cellular network standards will be evident to the person skilled in the art.

There is claimed:

1. A method of managing a mobile infrastructure mobile radio network, including:
setting up a connection between said mobile infrastructure mobile radio network and a fixed telephone network via a satellite when said mobile infrastructure mobile radio network is far away from any fixed infrastructure mobile radio network with which it could set up a radio link, and
setting up a radio link between said mobile infrastructure mobile radio network and a fixed infrastructure mobile radio network when said mobile infrastructure mobile radio network is near said fixed infrastructure mobile radio network and they can set up a radio link between them.

2. The method claimed in claim 1 wherein, to prevent the risk of simultaneous use of the same frequency in said mobile infrastructure mobile radio network and in a fixed infrastructure mobile radio network, the method further includes:
having said mobile infrastructure network detect transmission in a fixed infrastructure mobile radio network, and
having said fixed infrastructure mobile radio network initiate a frequency determination and sharing procedure.

3. The method claimed in claim 1 wherein transmissions in a fixed infrastructure mobile radio network are detected by frequency scanning to determine beacon channels transmitted by base stations in a fixed infrastructure mobile radio network and identifying nearby fixed mobile networks on the basis of identification information contained in each of said channels.

4. The method claimed in claim 1 wherein said frequency determination and sharing procedure further consists in considering cells defined by said base stations specific to said mobile infrastructure mobile radio network as cells of said fixed infrastructure mobile radio network and then allocating frequencies usable in common by both networks to base stations of said mobile infrastructure network, said frequencies being chosen from among those used by base stations situated out of radio range.

5. A mobile infrastructure for a mobile radio network, including:
means for setting up a connection between said mobile infrastructure mobile radio network and a fixed telephone network via a satellite when said mobile infrastructure mobile radio network is far away from any fixed infrastructure mobile radio network with which it could set up a radio link; and
means for setting up a radio link between said mobile infrastructure mobile radio network and a fixed infrastructure mobile radio network when said mobile infrastructure mobile radio network is near said fixed infrastructure mobile radio network and they can set up a radio link between them.

6. The infrastructure claimed in claim 5 wherein, to avoid the risk of simultaneous use of the same frequency in said mobile infrastructure mobile radio network and in a fixed infrastructure mobile radio network, it further includes means for:
detecting transmission in a fixed infrastructure mobile radio network, and
initiating a procedure for determining and sharing frequencies with a fixed infrastructure mobile radio network that has been detected.
